(19) United States
(12) Patent Application Publication
(10) Pub. No.: US 2020/0165137 A1
(43) Pub. Date: May 28, 2020

(54) HIGHLY ORIENTED GRAPHITE AND METHOD FOR PRODUCING HIGHLY ORIENTED GRAPHITE

(71) Applicant: KANEKA CORPORATION, Osaka (JP)

(72) Inventors: Makoto Kutsumizu, Osaka (JP); Yasushi Nishikawa, Osaka (JP); Yuusuke Kato, Osaka (JP)

(73) Assignee: KANEKA CORPORATION, Osaka (JP)

(21) Appl. No.: 16/094,618

(22) PCT Filed: Apr. 21, 2017
(86) PCT No.: PCT/JP2017/015963

§ 371 Date: Oct. 18, 2018

(30) Foreign Application Priority Data
Apr. 22, 2016 (JP) 2016-086367

(51) Int. Cl. C01B 32/205; B32B 27/28; B32B 27/08; B32B 9/00; B32B 9/04

(52) U.S. Cl. CPC C01B 32/205; B32B 27/281; B32B 27/08; B32B 2250/05; B32B 9/045; C01P 2006/10; B32B 2250/40; B32B 9/007

(57) ABSTRACT

Thin, highly oriented graphite of good quality can be produced by adjusting pressures to be applied to a laminate, i.e., a raw material, during the carbonizing step and during the graphitizing step.

### TECHNICAL FIELD

The present invention relates to highly oriented graphite and a method of producing the highly oriented graphite.

### BACKGROUND ART

In order to solve the problem of heat generation in an electronic device, there has been a demand for a heat dissipation member that prevents an increase in temperature of the electronic device by efficiently transferring heat generated by the heat source to a low temperature portion. A graphite sheet has conventionally been used as such a heat dissipation member (see, for example, Patent Literatures 1 to 3).

Recent years have seen a demand for a material having a heat dissipation property or a heat transfer property that is further greater than that of the above-described graphite sheet. As such a material, attention has been drawn to thick, highly oriented graphite including layers of graphite (hereinafter referred to as “graphite layers”) that are stacked on top of one another in a stacking direction to a thickness of not less than 20 mm. Highly oriented graphite refers to graphite including highly oriented graphite layers, specifically to graphite having a thermal conductivity of not less than 800 W/mK in a direction in which the graphite layers are oriented.

Examples of the method of producing thick, highly oriented graphite include a method including a step of graphitizing a laminate of a plurality of polymeric films stacked on top of one another or a laminate of a plurality of carbonaceous films stacked on top of one another at a high temperature while applying a pressure of not less than 20 kg/cm² to the laminate (see, for example, Patent Literature 4).

Thick, highly oriented graphite serves a useful function when used in a relatively large electronic device. However, with development of small electronic devices such as smartphones, there has recently been an increasing demand for thin, highly oriented graphite that can be used in such small electronic devices as well.

### CITATION LIST

### Patent Literature

[Patent Literature 1] Japanese Patent Application Publication Tokukai No. 2009-295921
[Patent Literature 2] Japanese Patent Application Publication Tokukaihei No. 7-109171 (1995)
[Patent Literature 3] Japanese Patent Application Publication Tokukai No. 2008-305917
[Patent Literature 4] International Publication No. WO 2015/129317 A1

### SUMMARY OF INVENTION

### Technical Problem

With the increasing demand for thin, highly oriented graphite, attempts have been made to produce such thin, highly oriented graphite according to a method of producing thick, highly oriented graphite.

Those attempts, however, turned out that thin, highly oriented graphite of good quality cannot be produced by a method of producing thick graphite.

In the method of producing thick, highly oriented graphite, for example, it is necessary to apply a high pressure to the material during the graphitizing step. In order to apply a high pressure to the material, it is necessary to use a special furnace. The size of such a special furnace limits the size of resultant highly oriented graphite. It was therefore impossible to produce thin, large, highly oriented graphite by the method of producing thick graphite.

The present invention has been attained to address the above problem, and an object of the present invention is to provide thin, highly oriented graphite and a method of producing the thin, highly oriented graphite.

### Solution to Problem

In view of the above object, the inventors of the present invention made diligent studies, and consequently accomplished the present invention by finding that thin, highly oriented graphite of good quality can be produced through the application of a low pressure to the material during the graphitizing step, in contrast to the conventional know-how that thick, highly oriented graphite is produced through the application of a high pressure to the material during the graphitizing step.

Highly oriented graphite in accordance with an aspect of the present invention includes: graphite layers stacked on top of one another, the highly oriented graphite (i) having a thickness of not less than 8 μm and not more than 1 mm in a stacking direction of the graphite layers, (ii) having, on a surface thereof, a plane lying in a plane direction of the graphite layers, the plane having an area of not less than 225 mm², and (iii) having a density of not less than 1.60 g/cm³ and not more than 2.15 g/cm³.

A method of producing highly oriented graphite in accordance with an aspect of the present invention includes: a carbonizing step of heating a laminate including a plurality of polymeric films being stacked on top of one another and each having a thickness of not less than 1 μm and less than 50 μm, at a maximum temperature of not less than 700° C. and not more than 1500° C.; and a graphitizing step of heating the laminate, having been subjected to the carbonizing step, at a maximum temperature of not less than 2700° C., during the carbonizing step, a pressure of not less than 0.2 kg/cm² being applied to the laminate, and during the graphitizing step, a pressure of not more than 1.0 kg/cm² or no pressure being applied to the laminate.

### Advantageous Effects of Invention

An aspect of the present invention allows for highly oriented graphite suitable for die-cutting.

An aspect of the present invention allows for thin, large, highly oriented graphite.

An aspect of the present invention allows for highly oriented graphite including graphite layers that have a high degree of adhesion to one another.

An aspect of the present invention allows for highly oriented graphite with fewer cracks.

### BRIEF DESCRIPTION OF DRAWINGS

FIG. 1 is a view schematically illustrating highly oriented graphite in accordance with an aspect of the present invention.

FIG. 2 is an image of lifts having occurred between graphite layers.

### DESCRIPTION OF EMBODIMENTS

The description below will deal with embodiments of the present invention, but the present invention is not limited to such embodiments. The present invention is not limited to any configuration described below, and can be altered in various ways within the scope of the claims. Any embodiment or example based on a proper combination of technical means disclosed in different embodiments and examples is also encompassed in the technical scope of the present invention. All academic and patent literatures listed herein are incorporated herein by reference. Unless otherwise specified herein, any numerical range expressed as “A to B” refers to “not less than A (A or more) and not more than B (B or less)”.

Highly oriented graphite in accordance with the present embodiment includes graphite layers stacked on top of one another. Note that the “graphite layer” as used herein refers to graphene, and the “highly oriented graphite” as used herein refers to graphite having a thermal conductivity of not less than 800 W/mK in a direction in which the graphite layers are oriented.

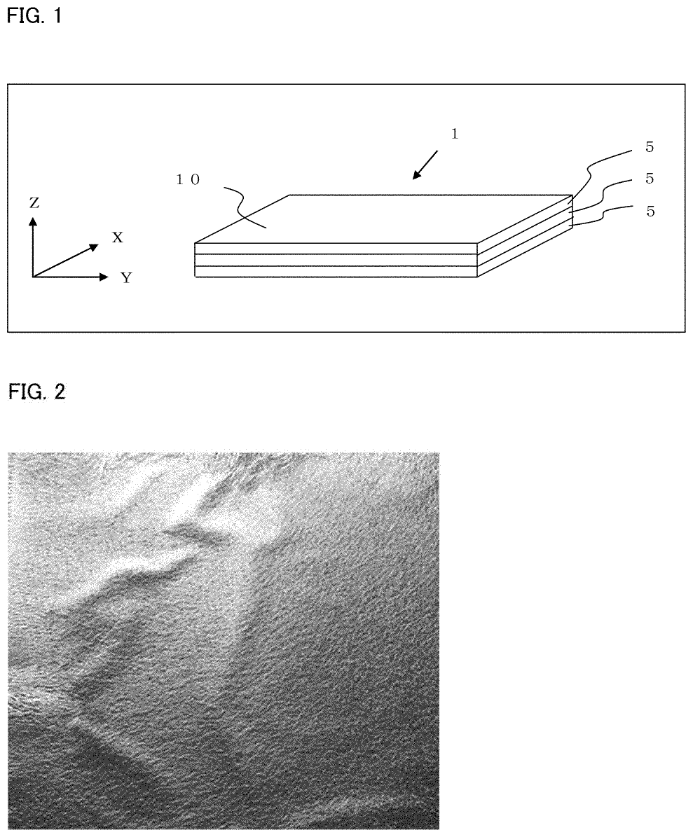

As illustrated in FIG. 1, highly oriented graphite 1 includes a plurality of graphite layers 5 stacked on top of one another. The plurality of graphite layers 5 each lie on the plane defined by the X and Y axes. The plurality of graphite layers 5 are stacked on top of one another in the direction of the Z axis, thereby forming the highly oriented graphite 1. The highly oriented graphite 1 has, on its surface, a plane 10 formed by the outermost graphite layer 5 (see FIG. 1). Note that the “stacking direction” as used herein refers to the direction of the Z axis indicated in FIG. 1, and the “plane direction” as used herein refers to the direction that is defined by the X axis and/or the Y axis each indicated in FIG. 1. The plurality of graphite layers 5 illustrated in FIG. 1 can be derived from identical polymeric films or different polymeric films, and their origins are not limited.

(Thickness of Highly Oriented Graphite in Stacking Direction)

The highly oriented graphite in accordance with the present embodiment has a thickness of not less than 8 μm and not more than 1 mm in the stacking direction. Thin, highly oriented graphite can be produced by a method of producing highly oriented graphite in accordance with an embodiment(s) described later. The thickness of the highly oriented graphite in the stacking direction is therefore not limited to the above-described thickness, and is more preferably not less than 50 μm and not more than 400 μm, not less than 100 μm and not more than 200 μm, not less than 105 μm and not more than 128 μm, or not less than 110 μm and not more than 125 μm. The configuration makes it possible to improve the heat dissipation property or the heat transfer property of a small electronic device in which the highly oriented graphite in accordance with the present embodiment is used as a heat dissipation material or a heat transfer material. The configuration also allows for highly oriented graphite that is easy to process (e.g., easy to die-cut).

(Shape of Highly Oriented Graphite)

The highly oriented graphite in accordance with the present embodiment has, on its surface, a plane lying in the plane direction of the plurality of graphite layers and having an area of not less than 225 mm² (see, for example, the plane 10 illustrated in FIG. 1). Highly oriented graphite with a large area can be produced by a method of producing highly oriented graphite in accordance with an embodiment(s) described later. The area of the above-described plane is therefore not limited to the above-described area, and can be not less than 500 mm², not less than 1000 mm², not less than 5000 mm², not less than 10000 mm², not less than 20000 mm², not less than 30000 mm², not less than 40000 mm², or not less than 50000 mm². Note that no particular upper limit is placed on the area of the above-described plane.

In the method of producing thick, highly oriented graphite, it is necessary to apply a high pressure to the material during the graphitizing step. In order to apply a high pressure to the material, it is necessary to use a special furnace (specifically, a small furnace). The size of such a special furnace limits the size of highly oriented graphite. In contrast, the present invention does not necessitate the application of a high pressure to the material during the graphitizing step, and therefore does not require the use of a special furnace (in other words, the present invention allows for the use of a large furnace). This makes it possible to produce highly oriented graphite that is not only thin but also large.

(Density of Highly Oriented Graphite)

The highly oriented graphite in accordance with the present embodiment has a density of not less than 1.60 g/cm³ and not more than 2.15 g/cm³. The density has an upper limit of preferably 2.10 g/cm³, and more preferably 2.00 g/cm³. The density has a lower limit of preferably 1.85 g/cm³, and more preferably 1.90 g/cm³. More specifically, the highly oriented graphite in accordance with the present embodiment preferably has a density of not less than 1.85 g/cm³ and not more than 2.00 g/cm³. With the configuration, the highly oriented graphite has moderate softness (in other words, the highly oriented graphite does not have excessive hardness). This allows for highly oriented graphite that (i) exhibits excellent ease of handling during the processing (e.g., die-cutting) and (ii) has fewer lifts after the die-cutting.

(Property 1 of Highly Oriented Graphite)

The highly oriented graphite in accordance with the present embodiment is preferably rated “A” or “B” in a case where the highly oriented graphite is evaluated by the following criteria: “C” given when a highly oriented graphite piece, which is cut out of the highly oriented graphite with the use of a die (e.g., a die having a size of 50 mm×50 mm, more specifically a pinnacle die having a size of 50 mm×50 mm), has a delamination or a crack; “B” given when the highly oriented graphite piece has a burr; and “A” given when the highly oriented graphite piece has no delamination, crack, or burr. The configuration allows for highly oriented graphite that exhibits excellent ease of handling during the processing. Note that the highly oriented graphite piece having a burr refers to a state where a die-shaped highly oriented graphite piece, which has been cut out of the highly oriented graphite with the use of a die, has a graphite portion protruding out through the edge of the die-shaped highly oriented graphite piece. For example, the highly oriented graphite piece having a burr refers to a state where a highly oriented graphite piece, which has been cut out of the highly oriented graphite with the use of a die having a size of 50 mm×50 mm, has (i) a graphite portion (having a size of 50 mm×50 mm) which is of identical shape with the die and (ii) another graphite portion which is not of identical shape with the die.

Note that the occurrences of a delamination, a crack, and a burr can be determined according to the methods explained in Examples described later.

(Property of Highly Oriented Graphite-2)

The highly oriented graphite in accordance with the present embodiment is preferably rated “A” or “B” in a case where the highly oriented graphite is evaluated by the following criteria: “C” given when the highly oriented graphite has, in a given region of 200 mm×200 mm and between the graphite layers, not less than 5 lifts each having a length of not less than 3 cm in the plane direction; “B” given when the highly oriented graphite has, in the given region of 200 mm×200 mm and between the graphite layers, 1 to 4 lifts each having a length of not less than 3 cm in the plane direction; and “A” given when the highly oriented graphite has no lift in the given region of 200 mm×200 mm and between the graphite layers. The configuration allows for highly oriented graphite that exhibits excellent ease of handling during the processing (e.g., die-cutting). Note that the lift between the graphite layers refers to a state where a space is formed between the graphite layers because the graphite layers have failed to adhere to each other during the heat treatment step. The lift may have a linear shape or a round shape, but the shape of the lift is not limited to them.

Note that the occurrence of a lift can be determined according to the method explained in Examples described later.

(Method of Producing Highly Oriented Graphite)

The highly oriented graphite in accordance with the present embodiment is produced by (i) stacking a plurality of polymeric films or a plurality of carbonaceous films directly on top of one another and (ii) heating the laminate up to a temperature of not less than 2400° C.

Specifically, the highly oriented graphite is produced through (i) a carbonizing step of preheating polymeric films up to a temperature of approximately 1000° C. so as to prepare carbonaceous films and (ii) a graphitizing step of heating the carbonaceous films thus prepared in the carbonizing step up to a temperature of not less than 2400° C. so as to graphitize the carbonaceous films. A carbonaceous film prepared through the carbonizing step is glassy, and has a weight that is approximately 60% of that of a polymeric film. The graphitizing step allows for carbon rearrangement in the graphite layers, with the result of high orientation. Note that the carbonizing step and the graphitizing step can be consecutively carried out or, alternatively, the graphitizing step can be separately carried out after the end of the carbonizing step.

(Carbonizing Step)

The carbonizing step is a step of heat-treating a laminate of a plurality of polymeric films stacked on top of one another up to a temperature of approximately 1000° C. (e.g., with a maximum temperature of not less than 700° C. and not more than 1500° C.) while applying a load to the laminate, so as to carbonize the plurality of polymeric films.

The load applied during the carbonizing step is not less than 0.2 kg/cm². Application of a load of not less than 0.2 kg/cm² during the carbonizing step allows for good adhesion between the polymeric films, and consequently allows for good adhesion between the carbonaceous films. This allows for highly oriented graphite including graphite layers that (i) have good adhesion to one another and (ii) are not excessively compressed, even in a case where the load applied during the graphitizing step described later is made lower.

More specifically, the load applied during the carbonizing step is preferably not less than 0.2 kg/cm² and not more than 10 kg/cm², more preferably not less than 0.3 kg/cm² and not more than 10 kg/cm², and most preferably not less than 0.4 kg/cm² not more than 5 kg/cm².

The temperature increase rate during the carbonizing step is not limited to any particular rate, but preferably falls within a range of 0.2° C./min to 5° C./min. A temperature increase rate of not more than 5° C./min allows for slow discharge of cracked gas generated in the polymeric films during the carbonization. This prevents the cracked gas from pushing up a polymeric film in a case where a plurality of polymeric films are stacked on top of one another, thereby allowing for a laminate of carbonaceous films that have better adhesion to one another. The temperature increase rate of not less than 0.2° C./min allows the polymeric films to be gradually carbonized from the outside thereof. This prevents rapid shrinkage of the polymeric films, and consequently prevents breakage of the carbonaceous films.

The polymeric films used in the present embodiment can be of at least one polymer selected from a polyimide, a polyamide, a polyoxadiazole, a polybenzothiazole, a polybenzobisthiazole, a polybenzoxazole, a polybenzobisoxasole, a polyparaphenylene vinylene, a polybenzimidazole, a polybenzobisimidazole, and a polythiazole. A polyimide film is particularly preferable as a raw material film for the graphite film in accordance with the present invention.

The polymeric films used in the present embodiment each have a thickness of not less than 1 μm and less than 50 μm, more preferably not less than 1 μm and not more than 25 μm, still more preferably not less than 1 μm and less than 25 μm, and particularly preferably not less than 1 μm and not more than 13 μm. The configuration allows for efficient discharge of cracked gas generated in the polymeric films, thereby allowing for thin, highly oriented graphite of better quality.

The number of polymeric films included in the laminate used during the carbonizing step is two or more, preferably 6 to 70, preferably 10 to 60, and particularly preferably 15 to 50.

The laminate of a plurality of polymeric films stacked on top of one another, which laminate is to be subjected to the carbonizing step, has a thickness of preferably not less than 200 μm and not more than 2 mm, preferably not less than 250 μm and not more than 2, and more preferably not less than 250 μm and not more than 1 mm. The thickness is, however, not limited to any particular thickness. The configuration allows for efficient discharge of cracked gas generated in the polymeric films, thereby allowing for thin, highly oriented graphite of further better quality.

(Graphitizing Step)

The graphitizing step is a step of heat-treating the laminate of the carbonaceous films up to a temperature of not less than 2400° C. (e.g., with a maximum temperature of not less than 2400° C., not less than 2500° C., not less than 2600° C., or not less than 2700° C.), so as to graphitize the laminate of the carbonaceous films. The laminate of the carbonaceous films refers to a laminate prepared by (i) stacking polymeric films on top of one another and then (ii) carbonizing the polymeric films thus stacked.

During the graphitizing step, a pressure of not more than 1.0 kg/cm² or no pressure is applied to the laminate of the carbonaceous films. Preferably, a pressure of not more than 0.5 kg/cm² or no pressure is applied to the laminate of the carbonaceous films. Application of a load of not more than 1.0 kg/cm² during the graphitization allows for highly oriented graphite in which (i) good adhesion is provided between graphite layers and (ii) the graphite layers are not excessively compressed. The highly oriented graphite therefore exhibits excellent ease of handling during the processing (e.g., die-cutting).

More specifically, the load applied during the graphitizing step is preferably not less than 0 kg/cm² and not more than 0.5 kg/cm², more preferably not less than 0 kg/cm² and not more than 0.3 kg/cm², still more preferably not less than 0 kg/cm² and not more than 0.1 kg/cm², and most preferably not less than 0 kg/cm² and not more than 0.05 kg/cm². Although the above-described numerical ranges each have a lower limit of “0 kg/cm²”, the lower limit can alternatively be “0.01 kg/cm²”.

During the graphitizing step, no load heavier than 1.0 kg/cm² is applied to the laminate of the carbonaceous films. According to the present embodiment, thin, highly oriented graphite of good quality can be produced through the application of a low pressure to the material during the graphitizing step, in contrast to the conventional know-how that thick, highly oriented graphite is produced through the application of a high pressure to the material during the graphitizing step.

Application of a pressure during the graphitizing step can be carried out within any temperature range of at least not less than 2400° C.

Application of a pressure during the graphitizing step is preferably continued until the end of the graphitizing step, but does not necessarily need to be continued until the end of the graphitizing step. The graphitizing step may allow the graphitization to progress at temperatures falling within the temperature range of not less than 2400° C. under no pressure as long as the graphitizing step includes, for example, applying a pressure at least once at temperatures falling within any temperature range of not less than 2400° C. Such a configuration is also encompassed by the scope of the present invention. More specifically, the scope of the present invention can also encompass, for example, (i) a method of graphitizing a laminate of carbonaceous films under pressure at temperatures from 2400° C. to 2500° C. and then allowing the graphitization to progress under no pressure at 2500° C. and higher temperatures, and (ii) a method of allowing the graphitization to progress under no pressure at temperatures from 2400° C. to 2500° C. and then graphitizing a laminate of carbonaceous films under pressure at 2500° C. and higher temperatures.

The temperature increase rate during the graphitizing step is not limited to a particular rate, but preferably falls within a range of 0.2° C./min to 10° C./min. The configuration is preferable because it allows for moderate discharge of internal gas, thereby preventing expansion of spaces between the graphite layers.

(Processing Step)

The method of producing the highly oriented graphite in accordance with the present embodiment can include a processing step of die-cutting a portion of the highly oriented graphite after the graphitizing step. Since the highly oriented graphite in accordance with the present embodiment has a property suitable for the die-cutting, the processing step allows highly oriented graphite having a desired shape to be processed with a high degree of accuracy.

The die used during the processing step is not limited to a particular die, and can be any desired die. The die can be, for example, a die having a size of 50 mm×50 mm, more specifically a pinnacle die having a size of 50 mm×50 mm, but is not limited to them.

(Application Purposes)

The highly oriented graphite in accordance with the present embodiment has an excellent heat conductivity, and therefore can be used for various application purposes related to heat. The highly oriented graphite is usable in, for example, smartphones, semiconductors (e.g., in-vehicle PCUs), semiconductor lasers, communication modules, and radars.

The present invention can be configured as below.

<1> Highly oriented graphite, including: graphite layers stacked on top of one another, the highly oriented graphite (i) having a thickness of not less than 8 μm and not more than 1 mm in a stacking direction of the graphite layers, (ii) having, on a surface thereof, a plane lying in a plane direction of the graphite layers, the plane having an area of not less than 225 mm², and (iii) having a density of not less than 1.60 g/cm³ and not more than 2.15 g/cm³.

<2> The highly oriented graphite as described in <1>, wherein the highly oriented graphite has a density of not less than 1.85 g/cm³ and not more than 2.00 g/cm³.

<3> The highly oriented graphite as described in <1> or <2>, wherein the thickness is not less than 110 μm and not more than 125 μm.

<4> The highly oriented graphite as described in any one of <1> to <3>, wherein the highly oriented graphite is rated “A” or “B” in a case where the highly oriented graphite is evaluated by the following criteria: “C” given when a highly oriented graphite piece, which is cut out of the highly oriented graphite with use of a die having a size of 50 mm×50 mm, has a delamination or a crack; “B” given when the highly oriented graphite piece has a burr; and “A” given when the highly oriented graphite piece has no delamination, crack, or burr.

<5> The highly oriented graphite as described in any one of <1> to <4>, wherein the highly oriented graphite is rated “A” or “B” in a case where the highly oriented graphite is evaluated by the following criteria: “C” given when the highly oriented graphite has, in a region of 200 mm×200 mm and between the graphite layers, not less than 5 lifts each having a length of not less than 3 cm in the plane direction; “B” given when the highly oriented graphite has, in the region of 200 mm×200 mm and between the graphite layers, 1 to 4 lifts each having a length of not less than 3 cm in the plane direction; and “A” given when the highly oriented graphite has no lift in the region of 200 mm×200 mm and between the graphite layers.

<6> A method of producing highly oriented graphite, including: a carbonizing step of heating a laminate including a plurality of polymeric films being stacked on top of one another and each having a thickness of not less than 1 μm and less than 50 μm, at a maximum temperature of not less than 700° C. and not more than 1500° C.; and a graphitizing step of heating the laminate, having been subjected to the carbonizing step, at a maximum temperature of not less than 2700° C., during the carbonizing step, a pressure of not less than 0.2 kg/cm² being applied to the laminate, and during the graphitizing step, a pressure of not more than 1.0 kg/cm² or no pressure being applied to the laminate.

<7> The method as described in <6>, further including a processing step of cutting out a portion of the laminate after the graphitizing step.

<8> The method as described in <6> or <7>, wherein the plurality of polymeric films each have a thickness of not less than 1 μm and not more than 13 μm.

<9> The method as described in any one of <6> to <8>, wherein the number of the plurality of polymeric films included in the laminate is not less than 15 and not more than 50.

<10> The method as described in any one of <6> to <9>, wherein during the carbonizing step, a pressure of not less than 0.3 kg/cm² and not more than 10 kg/cm² is applied to the laminate.

<11> The method described in any one of <6> to <10>, wherein during the graphitizing step, a pressure of not more than 0.5 kg/cm² or no pressure is applied to the laminate.

<12> The method as described in any one of <6> to <11>, wherein the plurality of polymeric films are each a polyimide film.

The present invention can alternatively be configured as below.

[1] Highly oriented graphite, including: graphite layers stacked on top of one another, the highly oriented graphite (i) having a thickness of not less than 8 μm and less than 20 mm in a stacking direction of the graphite layers, (ii) having, on a surface thereof, a plane lying in a plane direction of the graphite layers, the plane having an area of not less than 225 mm², and (iii) having a density of not less than 1.60 g/cm³ and not more than 2.15 g/cm³.

[2] The highly oriented graphite as described in [1], wherein the highly oriented graphite has a density of not more than 2.15 g/cm³.

[3] The highly oriented graphite as described in [1] or [2], wherein the highly oriented graphite is rated “A” or “B” in a case where the highly oriented graphite is evaluated by the following criteria: “C” given when a highly oriented graphite piece, which is cut out of the highly oriented graphite with use of a die having a size of 50 mm×50 mm, has a delamination or a crack; “B” given when the highly oriented graphite piece has a burr; and “A” given when the highly oriented graphite piece has no delamination, crack, or burr.

[4] The highly oriented graphite as described in any one of [1] to [3], wherein the highly oriented graphite is rated “A” or “B” in a case where the highly oriented graphite is evaluated by the following criteria: “C” given when the highly oriented graphite has, in a region of 200 mm×200 mm and between the graphite layers, not less than 5 lifts each having a length of not less than 3 cm in the plane direction; “B” given when the highly oriented graphite has, in the region of 200 mm×200 mm and between the graphite layers, 1 to 4 lifts each having a length of not less than 3 cm in the plane direction; and “A” given when the highly oriented graphite has no lift in the region of 200 mm×200 mm and between the graphite layers.

[5] A method of producing highly oriented graphite, including: a carbonizing step of heating a laminate including a plurality of polymeric films being stacked on top of one another, at a maximum temperature of not less than 700° C. and not more than 1500° C.; and a graphitizing step of heating the laminate, having been subjected to the carbonizing step, at a maximum temperature of not less than 2700° C., during the carbonizing step, a pressure of not less than 0.2 kg/cm² being applied to the laminate, and during the graphitizing step, a pressure of not more than 1.0 kg/cm² or no pressure being applied to the laminate.

[6] The method as described in [5], further including a processing step of cutting out a portion of the laminate after the graphitizing step.

[7] The method as described in [5] or [6], wherein the plurality of polymeric films each have a thickness of not less than 1 μm and less than 50 μm.

[8] The method as described in any one of [5] to [7], wherein the laminate to be subjected to the carbonizing step has a thickness of not less than 200 μm and not more than 2 mm.

[9] The method as described in any one of [5] to [8], wherein during the carbonizing step, a pressure of not more than 10 kg/cm² is applied to the laminate.

### EXAMPLES

<Die-Cutting Evaluation>

Out of obtained graphite, a graphite piece was cut with the use of a pinnacle die having a size of 50 mm×50 mm. The graphite was evaluated by the following criteria: “C” given when a graphite piece had a delamination or a crack; “B” given when the graphite piece had a burr; and “A” given when the graphite piece had no delamination, crack, or burr.

The occurrence of “delamination” was determined through visual inspection. Specifically, in a case where peeling between the graphite layers was observed at the outer peripheral edge of the graphite piece having a size of 50 mm×50 mm during the visual inspection, the graphite was determined to have delamination. In a case where no peeling between the graphite layers was observed at the outer peripheral edge of the graphite piece having a size of 50 mm×50 mm during the visual inspection, the graphite was determined to have no delamination.

The occurrence of a “crack” was determined through visual inspection. Specifically, in a case where a chip having a length of not less than 0.5 mm was observed in the graphite piece during the visual inspection, the graphite was determined to have a crack. In a case where no chip having a length of not less than 0.5 mm was observed in graphite piece during the visual inspection, the graphite was determined to have no crack.

The occurrence of a “burr” was determined through visual inspection. Specifically, in a case where a burr having a length of not less than 2 mm was observed at the outer peripheral edge of the graphite piece having a size of 50 mm×50 mm during the visual inspection, the graphite was determined to have a burr. In a case where no burr having a length of not less than 2 mm was observed at the outer peripheral edge of the graphite piece having a size of 50 mm×50 mm during the visual inspection, the graphite was determined to have no burr.

<Layer Lift Evaluation>

In the layer lift evaluation, the graphite was evaluated by the following criteria: “C” given when the obtained graphite had, in a given region of 200 mm×200 mm and between the graphite layers, not less than 5 lifts each having a length of not less than 3 cm in the plane direction; “B” given when the obtained graphite had, in the given region of 200 mm×200 mm and between the graphite layers, 1 to 4 lifts each having a length of not less than 3 cm in the plane direction; and “A” given when the obtained graphite had no lift between the graphite layers.

The occurrence of a “lift” was determined through visual inspection. FIG. 2 illustrates the image of a region of prepared graphite in which region lifts have occurred between the graphite layers. As illustrated in FIG. 2, in the region in which a lift has occurred between the graphite layers, for example, a bulge having a linear shape extends on the surface of the obtained graphite. On the basis of the results of (i) measurement of the length of the linear bulge and (ii) counting of the number of linear bulges having a given length, the graphite was rated “A”, “B”, or C. Note that the lift between the graphite layers refers to a state where a space is formed between the graphite layers because the graphite layers have failed to adhere to each other during the heat treatment step. The lift may have a round shape other than the above-described linear shape, but the shape of the lift is not limited to them. In regard to graphite having a lift having a shape (e.g., round shape) other than a linear shape, the maximum length of the shape was measured. Then, graphite was rated “A”, “B”, or “C” on the basis of the maximum length.

### Example 1

Twenty polyimide films each having a size of 220 mm×220 mm and a thickness of 12.5 μm were stacked on top of one another. Twenty natural graphite sheets each having a thickness of 200 μm and a graphite plate having a thickness of 10 mm were placed on top of the laminate of the polyimide films and beneath the laminate of the polyimide films. The laminate of the polyimide films, the natural graphite sheets, and the graphite plate were set in a carbonization furnace. In the carbonizing step, the laminate of the polyimide films was heated at a temperature increase rate of 0.5° C./min up to a temperature of 1400° C. while being pressed under a load of 10 kg/cm² per unit area, so as to obtain carbonized films composed of the twenty polyimide films adhering to one another. Next, in the graphitizing step, (i) a natural graphite sheet having a thickness of 200 μm was placed on top of the carbonized films and beneath the carbonized films, (ii) a graphite weight plate was placed over the carbonized films so that a load of 0.05 kg/cm² was applied to the carbonized films, (iii) the carbonized films, the natural graphite sheets, and the weight plate were placed in a graphitization furnace, and (iv) the carbonized films were heated at a temperature increase rate of 5° C./min up to 2900° C. so as to graphitize the carbonized films.

### Example 2

Graphite was produced as in Example 1 except that a load of 5 kg/cm² was applied during the carbonizing step.

### Example 3

Graphite was produced as in Example 1 except that a load of 0.4 kg/cm² was applied during the carbonizing step.

### Example 4

Graphite was produced as in Example 1 except that a load of 0.2 kg/cm² was applied during the carbonizing step.

### Comparative Example 1

Graphite was produced as in Example 1 except that a load of 0.05 kg/cm² was applied during the carbonizing step.

(Test Result 1)

Table 1 shows respective test results of Examples 1 to 4 and Comparative Example 1 in which different loads were applied in the carbonizing step. A comparison of those results reveals the following facts. Specifically, in Comparative Example 1 in which a load of 0.05 kg/cm² was applied in the carbonizing step, insufficient adhesion between the graphite layers resulted in the occurrences of lifts between the graphite layers. In contrast, in Examples 1 to 4 in each of which a load of not less than 0.2 kg/cm² was applied during the carbonization, fewer (or no) lifts occurred between the graphite layers. Furthermore, a comparison between Example 4 in which a load of 0.2 kg/cm² was applied and Example 3 in which a load of 0.4 kg/cm² was applied reveals that an increase in load applied during the carbonizing step allows for reduction in (i) lifts between the graphite layers and (ii) peeling between the graphite layers during the die-cutting. Moreover, a comparison of Examples 1 to 3 reveals that (i) lowering the load to a certain extent allows for reduction in graphite cracks and (ii) it is preferable to apply a load of 0.4 kg/cm² to 5 kg/cm² during the carbonizing step in order to reduce both cracks and layer lifts.

### Example 5

Graphite was produced as in Example 3 except that (i) polyimide films each having a thickness of 25 μm were used and (ii) the number of polyimide films stacked was reduced to 10.

### Comparative Example 2

Graphite was produced as in Example 3 except that (i) polyimide films each having a thickness of 50 μm were used and (ii) the number of polyimide films stacked was reduced to 5.

### Comparative Example 3

Graphite was produced as with Example 3 except that (i) polyimide films each having a thickness of 100 μm were used and (ii) the number of polyimide films stacked was reduced to 3.

(Test Result 2)

Table 1 also shows respective test results of Examples 3 and 5 and Comparative Examples 2 and 3. A comparison of those test results suggests that lifts between the graphite layers can be reduced by using polyimide films each having a thickness of less than 50 μm. This is because, in a case where polyimide films each having a thickness of not less than 50 μm are used, (i) gas generated in the films during the graphitizing step is hard to be discharged out of the films, (ii) the gas accumulates between the graphite layers, and therefore (iii) adhesion between the graphite layers cannot be kept. A comparison between Examples 3 and 5 reveals that lifts between the graphite layers can be further reduced by using polyimide films each having a further smaller thickness (e.g., of 12.5 μm or less).

### Example 6

Graphite was produced as in Example 3 except that a load of 0.1 kg/cm² was applied during the graphitizing step.

### Example 7

Graphite was produced as in Example 3 except that during the graphitizing step, the carbonized films were heat-treated while being pressed under a load of 1 kg/cm². Note that in Example 7, polyimide films each having a size of 110 mm×110 mm were used so as to conform to the size of the graphitization furnace used.

### Comparative Example 4

Graphite was produced as in Example 3 except that during the graphitizing step, the carbonized films were heat-treated while being pressed under a load of 2 kg/cm². Note that in Comparative Example 4, polyimide films each having a size of 110 mm×110 mm were used so as to conform to the size of the graphitization furnace used.

### Comparative Example 5

Graphite was produced as with Example 3 except that during the graphitizing step, the carbonized films were heat-treated while being pressed under a load of 40 kg/cm². Note that in Comparative Example 5, polyimide films each having a size of 110 mm×110 mm were used so as to conform to the size of the graphitization furnace used.

(Test Result 3)

Table 1 also shows respective test results of Examples 3, 6, and 7 and Comparative Examples 4 and 5 in which different loads were applied during the graphitizing step. A comparison of those test results reveals the following facts. Specifically, in Comparative Examples 4 and 5 in each of which a load of not less than 2 kg/cm² was applied during the graphitizing step, burrs and cracks occurred during the die-cutting. In Example 7 in which a load of 1 kg/cm² was applied, no crack occurred but a burr occurred in a graphite piece cut out of the graphite. In contrast, in Examples 3 and 6 in each of which a load of less than 1 kg/cm² was applied during the graphitizing step, there was observed no crack or burr. The reason for this seems to reside in that (i) application of a load of not more than 1 kg/cm² during the graphitizing step allowed a slight gap to be left in the graphite, and (ii) the gap thus left allowed stress that occurs during the die-cutting to be dispersed. It is also revealed that the density of the graphite (in other words, the ratio of gaps in the graphite) is preferably not more than 2.15 g/cm³.

### Example 8

Graphite was produced as in Example 3 except that the number of polyimide films stacked was increased to 40.

### Example 9

Graphite was produced as with Example 3 except that the number of polyimide films stacked was increased to 60.

(Test Result 4)

Table 1 also shows respective test results of Examples 3, 8, and 9 in which the number of polyimide films stacked was 20, 40, and 60, respectively. A comparison of those test results reveals the following facts. Specifically, in Examples 3 and 8 in which the number of polyimide films stacked was 20 and 40, respectively, (i) the graphite was rated “A” in the die-cutting evaluation and in the layer lift evaluation, and (ii) no burr or crack occurred during the die-cutting. This means that the number of polymeric films stacked is particularly preferably less than 60. Furthermore, in Examples 3 and 8 in which the resultant graphite had a density of 1.91 g/cm³ and a density of 1.85 g/cm³, respectively, (i) the graphite was rated “A” in the die-cutting evaluation and in the layer lift evaluation, and (ii) no burr or crack occurred during the die-cutting. This means that the density of the graphite (in other word, the ratio of gaps in the graphite) is particularly preferably not less than 1.85 g/cm³.

TABLE 1

| | Polymeric Film | | | | | Carbonization | | Graphitization | | | | | | |
|---|---|---|---|---|---|---|---|---|---|---|---|---|---|---|
| | | | | T | | Condition | | Condition | | Graphite | | | Evaluation | |
| | | T | NFS | (Total) | Size | TIR | Load | TIR | Load | Size | T | Density | Die- | Layer |
| | Type | μm | Piece | mm | mm | ° C./min | kg/cm² | ° C./min | kg/cm² | mm | um | g/cm³ | cutting | Lift |
| E 1 | PI | 12.5 | 20 | 0.25 | 220 × 220 | 0.5 | 10 | 5 | 0.05 | 200 × 200 | 115 | 2.00 | A | A |
| E 2 | PI | 12.5 | 20 | 0.25 | 220 × 220 | 0.5 | 5 | 5 | 0.05 | 200 × 200 | 115 | 2.00 | A | A |
| E 3 | PI | 12.5 | 20 | 0.25 | 220 × 220 | 0.5 | 0.4 | 5 | 0.05 | 200 × 200 | 120 | 1.91 | A | A |
| E 4 | PI | 12.5 | 20 | 0.25 | 220 × 220 | 0.5 | 0.2 | 5 | 0.05 | 200 × 200 | 127 | 1.81 | B | B |
| E 5 | PI | 25 | 10 | 0.25 | 220 × 220 | 0.5 | 0.4 | 5 | 0.05 | 200 × 200 | 140 | 1.64 | B | B |
| E 6 | PI | 12.5 | 20 | 0.25 | 220 × 220 | 0.5 | 0.4 | 5 | 0.1 | 200 × 200 | 118 | 1.93 | A | A |
| E 7 | PI | 12.5 | 20 | 0.25 | 110 × 110 | 0.5 | 0.4 | 5 | 1 | 100 × 100 | 107 | 2.15 | B | A |
| E 8 | PI | 12.5 | 40 | 0.50 | 220 × 220 | 0.5 | 0.4 | 5 | 0.05 | 200 × 200 | 120 | 1.85 | A | A |
| E 9 | PI | 12.5 | 60 | 0.75 | 220 × 220 | 0.5 | 0.4 | 5 | 0.05 | 200 × 200 | 120 | 1.79 | B | B |
| CE 1 | PI | 12.5 | 20 | 0.25 | 220 × 220 | 0.5 | 0.05 | 5 | 0.05 | Not | — | — | — | C |
| | | | | | | | | | | Acquired | | | | |
| CE 2 | PI | 50 | 5 | 0.25 | 220 × 220 | 0.5 | 0.4 | 5 | 0.05 | Not | — | — | — | C |
| | | | | | | | | | | Acquired | | | | |
| CE 3 | PI | 100 | 3 | 0.30 | 220 × 220 | 0.5 | 0.4 | 5 | 0.05 | Not | — | — | — | C |
| | | | | | | | | | | Acquired | | | | |
| CE 4 | PI | 12.5 | 20 | 0.25 | 110 × 110 | 0.5 | 0.4 | 5 | 2 | 100 × 100 | 104 | 2.20 | C | A |
| CE 5 | PI | 12.5 | 20 | 0.25 | 110 × 110 | 0.5 | 0.4 | 5 | 40 | 100 × 100 | 103 | 2.22 | C | A |

*“E” refers to “Example”, “CE” refer to “Comparative Example”, “T” refers to “Thickness”, “NFS” refers to “Number of Films Stacked”, and “TIR” refers to “Temperature Increase Rate”.

### INDUSTRIAL APPLICABILITY

The highly oriented graphite in accordance with an embodiment of the present invention, which is not only excellent in heat conductivity but also thin, can be used as a heat transfer material or a heat dissipation material for various electronic devices such as smartphones, semiconductors (e.g., in-vehicle PCUs), semiconductor lasers, communication modules, and radars.

### REFERENCE SIGNS LIST

1: Highly oriented graphite
5: Graphite layer
10: Plane

1. Highly oriented graphite, comprising:
graphite layers stacked on top of one another,
wherein the highly oriented graphite has:
(i) a thickness of not less than 8 μm and not more than 1 mm in a stacking direction of the graphite layers,
(ii) on a surface thereof, a plane lying in a plane direction of the graphite layers, the plane having an area of not less than 225 mm², and
(iii) a density of not less than 1.60 g/cm³ and not more than 2.15 g/cm³.

2. The highly oriented graphite as set forth in claim 1, wherein the highly oriented graphite has a density of not less than 1.85 g/cm³ and not more than 2.00 g/cm³.

3. The highly oriented graphite as set forth in claim 1, wherein the thickness is not less than 110 μm and not more than 125 μm.

4. The highly oriented graphite as set forth in claim 1, wherein the highly oriented graphite is rated “A” or “B” in a case where the highly oriented graphite is evaluated by the following criteria: “C” given when a highly oriented graphite piece, which is cut out of the highly oriented graphite with use of a die having a size of 50 mm×50 mm, has a delamination or a crack; “B” given when the highly oriented graphite piece has a burr; and “A” given when the highly oriented graphite piece has no delamination, crack, or burr.

5. The highly oriented graphite as set forth in claim 1, wherein the highly oriented graphite is rated “A” or “B” in a case where the highly oriented graphite is evaluated by the following criteria: “C” given when the highly oriented graphite has, in a region of 200 mm×200 mm and between the graphite layers, not less than 5 lifts each having a length of not less than 3 cm in the plane direction; “B” given when the highly oriented graphite has, in the region of 200 mm×200 mm and between the graphite layers, 1 to 4 lifts each having a length of not less than 3 cm in the plane direction; and “A” given when the highly oriented graphite has no lift in the region of 200 mm×200 mm and between the graphite layers.

6. A method of producing highly oriented graphite, comprising:
a carbonizing step of heating a laminate including a plurality of polymeric films being stacked on top of one another and each having a thickness of not less than 1 μm and less than 50 μm, at a maximum temperature of not less than 700° C. and not more than 1500° C.; and
a graphitizing step of heating the laminate, having been subjected to the carbonizing step, at a maximum temperature of not less than 2700° C.,
wherein during the carbonizing step, a pressure of not less than 0.2 kg/cm² is applied to the laminate, and
wherein during the graphitizing step, a pressure of not more than 1.0 kg/cm² or no pressure is applied to the laminate.

7. The method as set forth in claim 6, further comprising a processing step of cutting out a portion of the laminate after the graphitizing step.

8. The method as set forth in claim 6, wherein the plurality of polymeric films each have a thickness of not less than 1 μm and not more than 13 μm.

9. The method as set forth in claim 6, wherein the number of the plurality of polymeric films included in the laminate is not less than 15 and not more than 50.

10. The method as set forth in claim 6, wherein during the carbonizing step, a pressure of not less than 0.3 kg/cm² and not more than 10 kg/cm² is applied to the laminate.

11. The method as set forth in claim 6, wherein during the graphitizing step, a pressure of not more than 0.5 kg/cm² or no pressure is applied to the laminate.

12. The method as set forth in claim 6, wherein the plurality of polymeric films are each a polyimide film.
